(19) United States
(12) Patent Application Publication
(10) Pub. No.: US 2005/0138128 A1
(43) Pub. Date: Jun. 23, 2005

(54) Method and device for grab transferring an instant messaging and presence (IMP) session

(76) Inventors: Uri S. Baniel, Highland Park, IL (US); Lang Xu, Schaumburg, IL (US)

Correspondence Address: MOTOROLA INC, 600 NORTH US HIGHWAY 45, ROOM AS437, LIBERTYVILLE, IL, 60048-5343, US

(21) Appl. No.: 10/744,894

(22) Filed: Dec. 23, 2003

(51) Int. Cl. G06F 15/16

(52) U.S. Cl. 709/206

(57) ABSTRACT

A method for transferring an instant messaging and presence (IMP) session from a source device (101) to a target device (103) includes the steps of registering (130) the target device with an IMP server (105), sending (150, 152) historical IMP session information from the source device to the target device, and subscribing (170) the target device to the IMP server. The target device (103) initiates the transfer of historical IMP session information (thus, we refer to it as a “grab” or “grab transfer”), and the target device (103) may optionally instruct the source device (101) to de-register (160) from the IMP server (105). Related methods for the target device and the source device are disclosed as well as an electronic device operable to be either a source device or a target device.

### FIELD OF THE DISCLOSURE

This disclosure relates generally to instant messaging and presence (IMP) technology, and more particularly to transfer of IMP information.

### BACKGROUND OF THE DISCLOSURE

A Session Initiation Protocol (SIP) Instant Messaging (IM) user can use a new device to login and participate in an on-going IM session (chat) without having any impact on the old device or the current chat. The new device, however, does not have any log/history, presence status information, or addressing/presence information regarding the on-going IM session prior to the time of the new device joining the chat. Thus, there is a risk that the new device will not receive messages sent during the time period that the user is transitioning from the old device to the new device. Additionally, historical information regarding the chat is not transferred to the new device. With the amount of information available in an IM session, the information not available to the new device could be significant in both importance and amount.

The transition of a user from one device to another device is similar to the well-known telephone features of “call transfer,” “call parking,” or simply picking up an extension telephone while leaving the first telephone off-hook. With a voice call situation, the lack of information regarding the telephone conversation to-date is remedied by the participants suspending the conversation while the user is transitioning from one device to another or by summarizing the conversation. In an IMP situation, however, such low-tech solutions are both cumbersome and annoying. Additionally, during call transfer and call parking, the old device is the initiating device while the new device is passive.

Thus, there is a desire to transition from an old device to a new device during an active IM session without missing messages sent during the time period of the transition. There is also a desire to transfer information regarding an on-going IM session to a new device without interrupting the chat. There is also a desire for the new device to initiate the transfer rather than passively accept a transfer initiated by an old device. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 is an exemplary message flow diagram showing an aggressive grab of an active instant messaging and presence (IMP) session in accordance with a preferred embodiment.

FIG. 2 is an exemplary message flow diagram showing a passive grab of an active instant messaging and presence (IMP) session in accordance with the preferred embodiment.

FIG. 3 shows a flow chart for a target device in accordance with the preferred embodiment.

FIG. 4 shows a flow chart for a source device in accordance with the preferred embodiment.

FIG. 5 shows an exemplary electronic device configured for grab transferring an IMP session in accordance with the preferred embodiment.

### DETAILED DESCRIPTION OF THE PREFERRED EMBODIMENTS

A method for transferring an instant messaging and presence (IMP) session from a source device to a target device includes the steps of registering the target device with an IMP server, sending historical IMP session information from the source device to the target device, and subscribing the target device to the IMP server. The target device initiates the transfer of historical IMP session information (thus, we refer to it as a “grab” or “grab transfer”), and the target device may optionally instruct the source device to de-register from the IMP server. Related methods for the target device and the source device are disclosed as well as an electronic device operable to be either a source device or a target device.

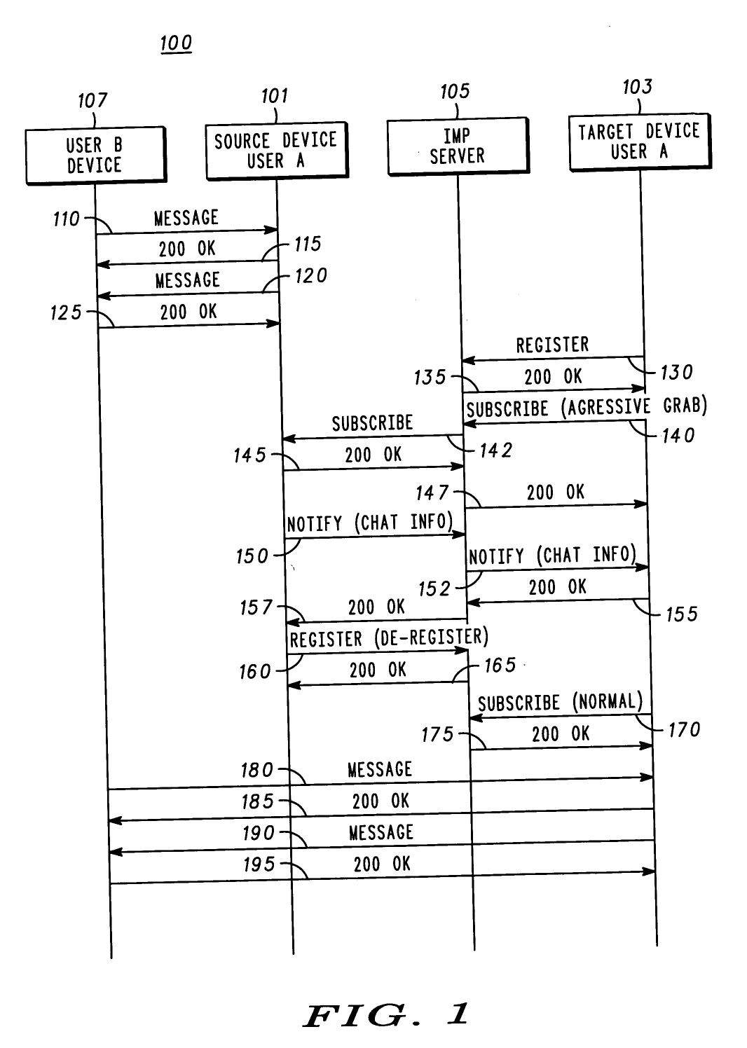

FIG. 1 is an exemplary message flow diagram 100 showing an aggressive grab of an active instant messaging and presence (IMP) session in accordance with a preferred embodiment. An aggressive grab transfers historical IMP session information originally sent between a User B device 107 and a User A source device 101 to a User A target device 103 and de-registers the source device 101 from an IMP server 105. The target device 103 initiates the transfer of historical IMP session information (thus, we refer to it as a “grab” or “grab transfer”), and the target device 103 also instructs the source device 101 to de-register from the IMP server 105. The IMP session transfer is seamless to User B. Note that User B's device 107 represents any number of IMP session participants. Also, any number of active IMP sessions can be grabbed by the target device 103 from the source device 101 by specifying a maximum amount of the historical IMP session information desired. This maximum amount, which may depend on the capabilities of the target device, can be indicated by selecting which chats to grab, the maximum amount of historical IMP session information (e.g., 1 KB) desired for each chat, the maximum cumulative amount of historical IMP session information (e.g., 4 KB) for all active chats, and the like.

The preferred embodiment uses Session Initiation Protocol (SIP); however, a grab transfer IMP session can be implemented using other protocols including proprietary protocols.

An active IMP session (or chat) is represented by messages 110, 115, 120, and 125. Naturally, any number of IMP messages can be passed between User B's device 107 and User A's source device 101 during the chat, and User A's device can be involved in more than one chat. Note that messages may be passed between User B's device 107 and User A's source device 101 directly (as shown) or via the IMP server 105 (not shown).

MESSAGE message 110 is a standard SIP IM message, which may include text, a picture, an icon, voice, or other data, sent from User B's device 107 to User A's source device 101. OK message 115 is an acknowledgement message that User A's source device 101 properly received MESSAGE message 110. Conversely, MESSAGE message 120 is a standard SIP IM message sent from User A's source device 101 to User B's device 107, and OK message 125 is an acknowledgement message that User B's device 107 properly received MESSAGE message 120.

At this point in the active IMP session, User A seeks to have a target device 103 aggressively grab the active IMP session from the source device 101. For instance, the source device 101 is an office desk phone or desktop computer. User A is leaving the office for the day and would like to continue the chat at the target device and discontinue the chat at the source device. Thus, User A turns on the target device 103, such as a cellular telephone, pager, laptop with wireless connection, or personal digital assistant with cellular connection, and launches an IMP software application that implements a grab transfer of an IMP session. In this exemplary message flow diagram 100, User A selects an aggressive grab of the on-going IMP session represented by messages 110, 115, 120, and 125.

Upon activating an aggressive grab of the IMP session, User A's target device 103 sends a REGISTER request message 130 to the IMP server 105. The REGISTER request message 130 preferably includes authentication information, such as challenge and response credentials, to authenticate the target device 103 to the IMP server 105. If the authentication is successful, the IMP server 105 acknowledges the REGISTER request message 130 with an OK message 135. Now, the target device 103 is registered with the IMP server 105, and other IMP users (such as User B) can see the presence status of the target device 103. As a result, even when the presence status of the old device later changes to ‘off,’ users will seamlessly continue to see the ‘online’ status of user A as presented by the target device. Also upon registration, appropriate accounting and network access is provided to the target device 103.

Next, the target device 103 sends a SUBSCRIBE message with an aggressive grab indicator to the source device 101 via the IMP server 105. This SUBSCRIBE request is a new type of request that is formatted to pass through the IMP server to the source device. The routing functionality of a SIP network automatically allows the target device to direct messages to the source device via the IMP server without fore-knowledge regarding the source device's internet protocol (IP) address and also without the source device initiating the grab transfer or even being aware of the grab transfer before it occurs. The IMP server has the task of locating the source device, which is both registered and subscribed.

Preferably, this SUBSCRIBE (aggressive grab) message includes authentication information, such as challenge and response credentials, to authenticate the target device 103 to the source device 101. The ability for the source device to authenticate the target device is a basic underlying element of the grab transfer. If both the source device and the target device belong to the same user, it is relatively easy to provision a shared secret known or associated only with the user. The SUBSCRIBE (aggressive grab) message 140 is sent to the IMP server 105, and the IMP server forwards the message to the source device 101 in SUBSCRIBE (aggressive grab) message 142. Assuming the authentication is successful, the source device 101 acknowledges receipt of the SUBSCRIBE (aggressive grab) message with an OK message 145, which is passed by the IMP server 105 to the target device 103 in OK message 147.

Next, the source device 101 transfers historical IMP session (chat) information in at least one NOTIFY message 150, which is passed by the IMP server 105 to the target device 103 in NOTIFY message 152. Preferably, the contents of the NOTIFY message include log/history information, presence status information, and addressing information regarding at least one current IMP session. The target device 103 acknowledges receipt of the chat information using OK message 155, which is passed from the IMP server 105 to the source device 101 in OK message 157.

At this point, or later, the source device 101 de-registers from the IMP session using REGISTER message 160, which de-registration is acknowledged by the IMP server 105 in OK message 165. (Note that SIP uses a REGISTER message with an expiration parameter, which when set to 0 indicates the REGISTER message is actually requesting de-registration.) De-registration can occur anytime after receipt of OK message 157, which indicates that IMP session historical information has successfully been transferred to the target device 103. De-registration of the source device 101 can occur either before, during, or after the time period that the target device 103 subscribes to the IMP server 105.

The target device 103 subscribes to the IMP server 105 using SUBSCRIBE message 170. This SUBSCRIBE message 170 is a normal subscribe message sent to an IMP server 105 when subscribing to an IMP session. The IMP server 105 acknowledges the SUBSCRIBE message 170 with an OK message 175. Now, the target device 103 has grabbed historical chat information from the source device 101, the target device 103 is subscribed to the active IMP session(s), and the source device 101 is de-registered from the IMP server.

Messages 180, 185, 190, and 195 represent the continuation of the active IMP session between User B's device 107 and User A's target device 103. MESSAGE message 180 is sent from User B's device 107 to User A's target device 103, and User A's target device acknowledges receipt with OK message 185. Conversely, User A's target device 103 sends a message 190 to User B's device, and User B's device acknowledges it with OK message 195. Like mentioned earlier, any number of IMP messages can be passed between User B's device 107 and User A's target device 103 during the continuation of the chat, and User A's device can be involved in more than one chat. Note that messages may be passed between User B's device 107 and User A's target device 103 directly (as shown) or via the IMP server 105 (not shown).

In order to avoid duplication of MESSAGE messages during the time period where an active IMP session is being grab transferred to a target device 103 from a source device 101, the target device 103 buffers chat messages received during the time interval starting with REGISTER message 130 and ending with the NOTIFY message 152. After receiving historical chat information in NOTIFY message 152, the target device 103 compares the contents of the buffer and discards duplicate chat messages before displaying them and continuing with the IMP session. If the IMP server is configured to provide IMP services only after receipt of a normal SUBSCRIBE request (such as SUBSCRIBE request 170), no duplicate chat messages should be found. If the IMP server is configured to provide IMP services before a normal SUBSCRIBE request (such as SUBSCRIBE request 170), e.g., immediately after a REGISTER request (such as REGISTER request 130), any duplicate chat messages will be discarded.

In order to avoid dropping MESSAGE messages received during the time interval starting with NOTIFY message 152 and ending with receipt of OK message 175, the source device 101 is allowed to de-register only after historical chat information has been acknowledged and received in OK message 157. At this time, the target device 103 subscribes to the IMP server using SUBSCRIBE message 170 and the IMP session continues with the target device 103.

Thus, the target device 103 initiates the transfer (i.e., grab transfer) and takes advantage of a SIP network's routing functionality to contact the source device 101 and request historical IMP session information from the source device 101. Additionally, in an aggressive grab situation, the target device 103 instructs the source device 101 to de-register from the IMP server 105 after providing historical IMP session information to the target device 103.

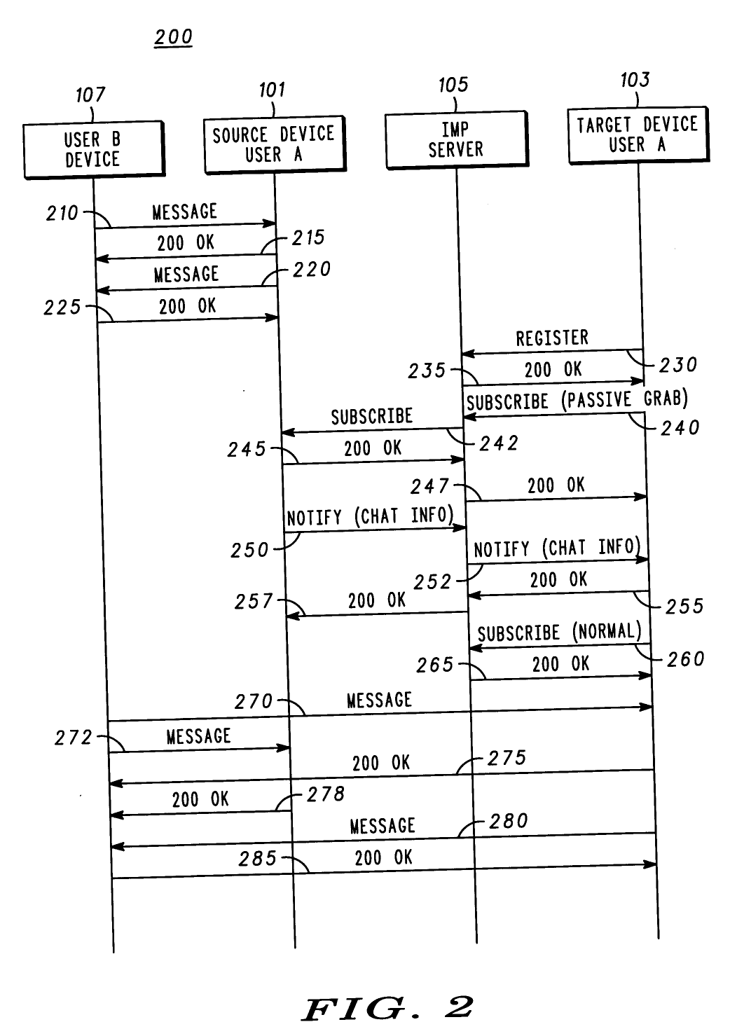

FIG. 2 is an exemplary message flow diagram 200 showing a passive grab of an active instant messaging and presence (IMP) session in accordance with the preferred embodiment. A passive grab transfers historical IMP session information originally sent between a User B device 107 and a User A source device 101 to a User A target device 103 without de-registering the source device 101 from the IMP server 105. The IMP session transfer is seamless to User B. Note that User B's device 107 represents any number of IMP session participants. Also, any number of IMP sessions can be grabbed by the target device 103 from the source device 101 by specifying a maximum amount of the historical IMP session information desired. This maximum amount, which may depend on the capabilities of the target device, can be indicated by selecting which chats to grab, the maximum amount of historical IMP session information (e.g., 1 KB) desired for each chat, the maximum cumulative amount of historical IMP session information (e.g., 4 KB) for all active chats, and the like.

The preferred embodiment uses Session Initiation Protocol (SIP); however, a grab transfer IMP session can be implemented using other protocols including proprietary protocols.

An active IMP session (or chat) is represented by messages 210, 215, 220, and 225. Naturally, any number of IMP messages can be passed between User B's device 107 and User A's source device 101 during the chat, and User A's device can be involved in more than one chat. Additionally, messages may be passed between User B's device 107 and User A's target device 103 either directly (as shown) or via the IMP server 105 (not shown).

MESSAGE message 210 is a standard SIP IM message, which may include text, a picture, an icon, voice, or other data, sent from User B's device 107 to User A's source device 101. OK message 215 is an acknowledgement message that User A's source device 101 properly received MESSAGE message 210. Conversely, MESSAGE message 220 is a standard SIP IM message sent from User A's source device 101 to User B's device 107, and OK message 225 is an acknowledgement message that User B's device 107 properly received MESSAGE message 220.

At this point in the active IMP session, User A seeks to have a target device 103 passively grab the active IMP session from the source device 101. For instance, the source device 101 is an office desk phone or desktop computer. User A is leaving the office for a brief period but would like to continue the chat at both the target device and the source device because she plans to return soon to the office. Thus, User A turns on the target device 103, such as a cellular telephone, pager, laptop with wireless connection, or personal digital assistant with cellular connection, and launches an IMP software application that implements a grab transfer of an IMP session. In this exemplary message flow diagram 200, User A selects a passive grab of the on-going IMP session represented by messages 210, 215, 220, and 225.

Upon activating a passive grab of the IMP session, User A's target device 103 sends a REGISTER request message 230 to the IMP server 105. The REGISTER request message 230 preferably includes authentication information, such as challenge and response credentials, to authenticate the target device 103 to the IMP server 105. If the authentication is successful, the IMP server 105 acknowledges the REGISTER request message 230 with an OK message 235. Now, the target device 103 is registered with the IMP server 105, and other IMP users (such as User B) can see the presence status of the target device 103. Also upon registration, appropriate accounting and network access is provided to the target device 103.

Next, the target device 103 sends a SUBSCRIBE message with a passive grab indicator to the source device 101 via the IMP server 105. This SUBSCRIBE request is a new type of request that is formatted to pass through the IMP server to the source device. The routing functionality of a SIP network automatically allows the target device to direct messages to the source device via the IMP server without fore-knowledge regarding the source device's internet protocol (IP) address and also without the source device initiating the grab transfer or even being aware of the grab transfer before it occurs. The IMP server has the task of locating the source device, which is both registered and subscribed.

Preferably, this SUBSCRIBE (passive grab) message includes authentication information, such as challenge and response credentials, to authenticate the target device 103 to the source device 101. The ability for the source device to authenticate the target device is a basic underlying element of the grab transfer. If both the source device and the target device belong to the same user, it is relatively easy to provision a shared secret known or associated only with the user. The SUBSCRIBE (passive grab) message 240 is sent to the IMP server 105, and the IMP server forwards the message to the source device 101 in SUBSCRIBE (passive grab) message 242. Assuming the authentication is successful, the source device 101 acknowledges receipt of the SUBSCRIBE (passive grab) message with OK message 245, which is passed by the IMP server 105 to the target device 103 in OK message 247.

Next, the source device 101 transfers historical IMP session (chat) information in at least one NOTIFY message 250, which is passed by the IMP server 105 to the target device 103 in NOTIFY message 252. Preferably, the contents of the NOTIFY message include log/history information, presence status information, and addressing information regarding the current IMP session. The target device 103 acknowledges receipt of the chat information using OK message 255, which is passed via the IMP server 105 to the source device 101 in OK message 257.

Next, the target device 103 subscribes to the IMP server 105 using SUBSCRIBE message 260. This SUBSCRIBE message 260 is a normal subscribe message sent to an IMP server 105 when subscribing to an IMP session. The IMP server 105 acknowledges the SUBSCRIBE message 260 with an OK message 265. Now, the target device 103 has grabbed historical chat information from the source device 101, the target device 103 is subscribed to the active IMP session, and the source device 101 is still registered with the IMP server.

Messages 270, 272, 275, 278, 280, and 285 represent the continuation of the active IMP session between User B's device 107, User A's source device 101, and User A's target device 103. MESSAGE message 270 is sent from User B's device 107 to User A's target device 103, and User A's target device acknowledges receipt with OK message 275. Additionally, MESSAGE message 272 (which is the same as MESSAGE message 270) is sent from User B's device 107 to User A's source device 101, and User A's source device acknowledges receipt with OK message 278. Conversely, User A's target device 103 sends a MESSAGE message 280 to User B's device 107, and User B's device acknowledges it with OK message 285 to User A's target device. Like mentioned earlier, any number of IMP messages can be passed between User B's device 107, User A's source device 101, and User A's target device during the continuation of the chat, and User A's devices can be involved in more than one chat. Additionally, messages may be passed between User B's device 107, User A's source device 101, and User A's target device 103 directly (as shown) or via the IMP server 105 (not shown).

The same considerations for avoiding duplication of MESSAGE messages described with reference to FIG. 1 apply to FIG. 2. By buffering certain messages and comparing the buffer contents with the historical IMP session information received from the source device, duplication of MESSAGE messages can be avoided.

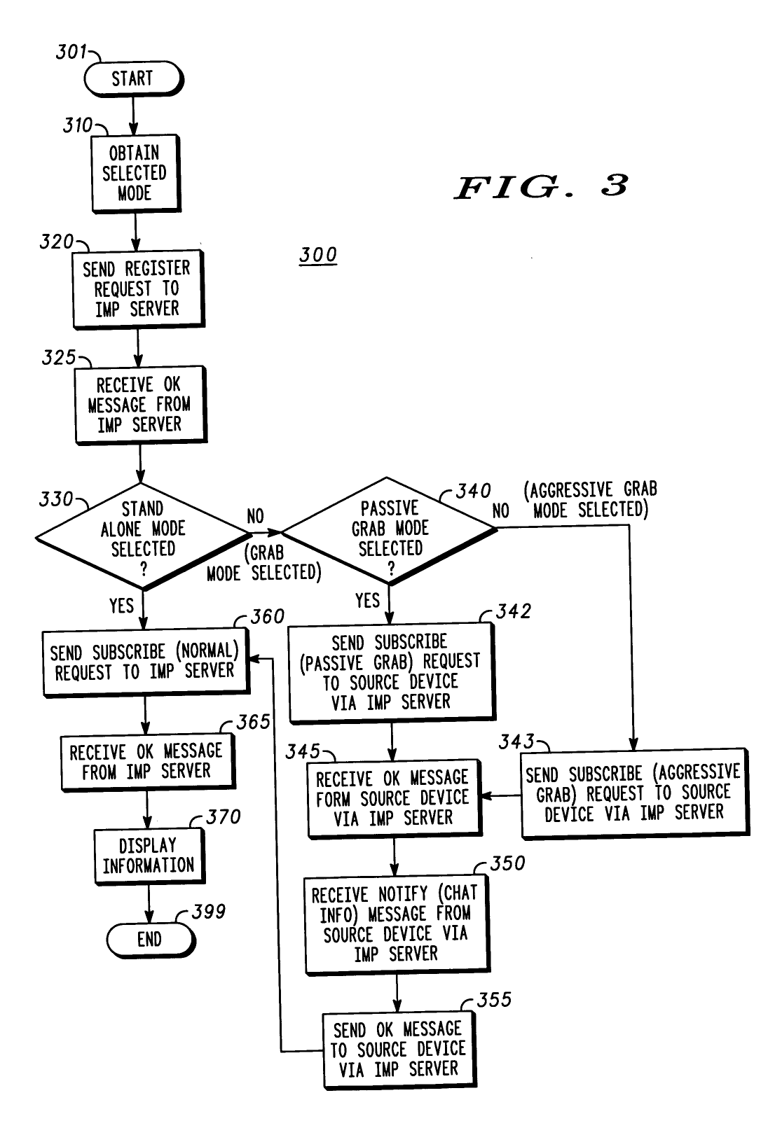

FIG. 3 shows a flow chart 300 for a target device in accordance with the preferred embodiment. The target device 103 shown in FIG. 1 and FIG. 2 implements this flow chart 300. The flow chart 300 can be implemented as a computer program operating in a processor of the target device or as program modules distributed in various processing units of the target device. The flow chart 300 provides steps for selecting a mode (aggressive grab, passive grab, or stand alone) after launching an instant messaging and presence software application on the target device.

The flow chart starts with step 301 when a user launches an IMP software application on the target device. Step 310 obtains a selected mode from the user. For example, upon first launch of the IMP application, the program may request a default mode for the IMP application of “stand alone” (which is the conventional mode where no historical IMP information is provided to the target device), “aggressive grab” (which is where historical IMP information is provided to the target device and the source device de-registers), or “passive grab” (where historical IMP information is provided to the target device and the source device remains registered). The default mode can be stored in a memory for access in step 310 upon subsequent launches of the IMP software application. Alternately, upon each launch of the IMP application, a mode selection is requested from the user. Other variations, such as mode selections or suggestions based on time of day, location of target device, number of active IMP sessions, and other variables can be used to obtain a selected mode in step 310.

Step 320 sends a REGISTER request to the IMP server, such as the IMP server 105 shown in FIG. 1 and FIG. 2. Although this flow chart assumes a SIP network, this flow chart can be generalized to other protocols. In step 325, the target device receives an acknowledge OK message from the IMP server, which indicates that the target device has been successfully authenticated to the IMP server. At this point, the target device is registered with the IMP server, and other users can see the presence status of the target device. Also, upon registration, appropriate accounting and network access is provided to the target device.

Step 330 determines if stand alone mode was selected as obtained in step 310. If stand alone mode was selected, step 360 sends a SUBSCRIBE request to the IMP server and step 365 receives an acknowledgement OK message from the IMP server. This is a standard SUBSCRIBE request, which allows the target device to see the status of devices who are on the user's “buddy list.” In step 370, the target device displays the device status, and the user can join an active chat and participate in other IMP functions. In the stand alone mode, however, the target device does not receive any historical IMP information from on-going chats, and the source device is not de-registered from the on-going chats.

If the selected mode is not “stand alone” as determined in step 330, then the selected mode is one of the two grab modes. Step 340 determines whether passive grab mode was selected. If passive grab mode was selected, step 342 sends a SUBSCRIBE request to the source device via the IMP server. This SUBSCRIBE request is a new type of request that is formatted to pass through the IMP server to the source device. The routing functionality of a SIP network automatically allows the target device to direct messages to the source device via the IMP server without fore-knowledge regarding the source device's internet protocol (IP) address and also without the source device initiating the grab transfer. The IMP server has the task of locating the source device, which is both registered and subscribed.

A parameter in this SUBSCRIBE request indicates a passive grab mode. Preferably, this SUBSCRIBE (passive grab) message includes authentication information, such as challenge and response credentials, to authenticate the target device to the source device. If the authentication is successful, in step 345 the target device receives an acknowledgement OK message from the source device via the IMP server.

Because the source device has received the SUBSCRIBE request with passive grab indicator, it sends at least one NOTIFY message to the target device via the IMP server. The NOTIFY message includes historical IMP session (chat) information for one or more active chats. Historical chat information includes one or more of the following types of information obtained by the source device: log/history information, presence status information, and addressing information regarding the current IMP session. The NOTIFY message is received at the target device via the IMP server in step 350, and the target device sends an acknowledgement OK message to the source device via the IMP server in step 355.

Now, the flow goes to step 360, which has been discussed earlier. Because of the additional steps 342, 345, 350, and 355 in the passive grab flow, when the target device subscribes at the IMP server, it has historical IMP session information before it joins an active chat.

If step 340 determines that passive grab mode was not selected in step 310, then (by process of elimination) aggressive grab mode was selected. In step 343, the target device sends a SUBSCRIBE request to the source device via the IMP server with a parameter indicating “aggressive grab” mode. The flow then goes to step 345, which has been described earlier. Like in passive grab mode, the target device receives historical IMP session information from the source device before subscribing and participating in on-going chats. The difference in aggressive grab mode is that the source device de-registers from the active chat after transferring the historical chat information.

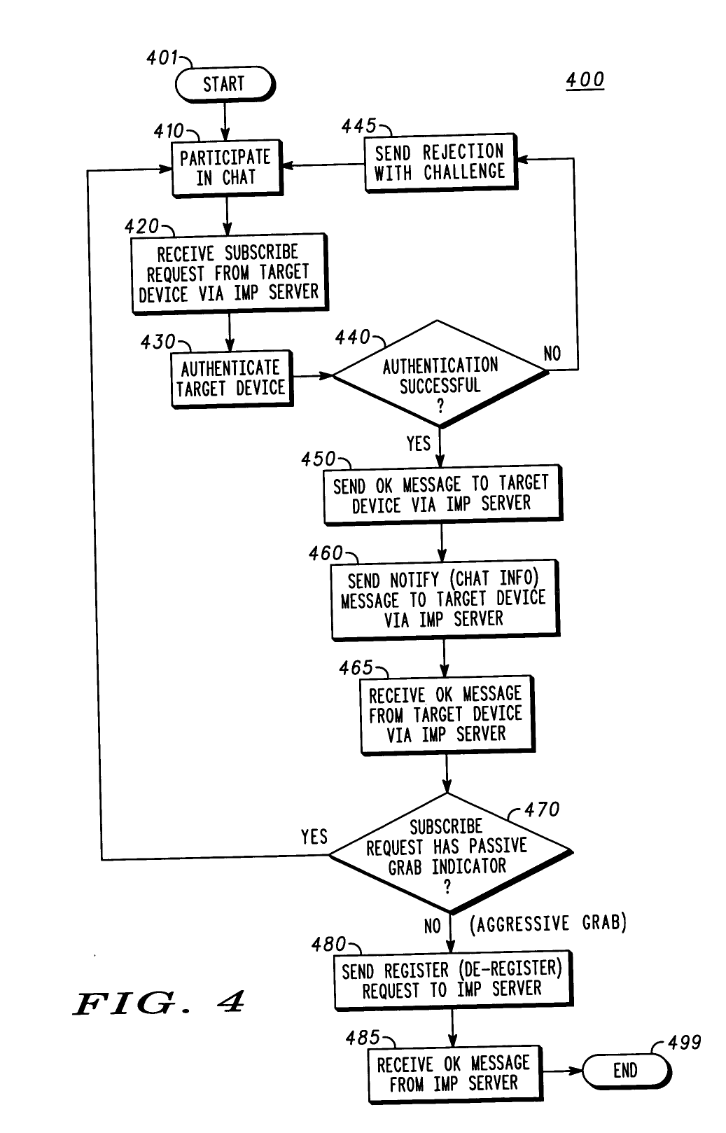

FIG. 4 shows a flow chart 400 for a source device in accordance with the preferred embodiment. The source device 101 shown in FIG. 1 and FIG. 2 implements this flow chart 400. The flow chart 400 can be implemented as a computer program operating in a processor of the source device or as program modules distributed in various processing units of the source device. The flow chart 400 provides steps for responding to a grab transfer request (aggressive grab or passive grab) of an active IMP session.

In start step 401, the source device is turned on, an IMP software application has been launched, and the source device has registered on the IMP server and subscribed to an on-going IMP session. In step 410, the source device participates normally in an IMP chat. In step 420, the source device receives a SUBSCRIBE request from the target device via the IMP server. Next, in step 430 the source device authenticates the target device. The authentication is performed using any appropriate authentication procedure, such as a challenge and response procedure. If the authentication is unsuccessful, as determined in step 440, the source device sends a rejection message with a challenge in step 445 to the target device via the IMP server. Then, the target device can include a response to the challenge in its SUBSCRIBE message received (for the second time) in step 420. If the authentication is successful, as determined in step 440, the source device sends an acknowledgement OK message to the target device via the IMP server in step 450.

Because the source device has received a SUBSCRIBE message from an authenticated target device, it sends at least one NOTIFY message to the target device via the IMP server in step 460. The NOTIFY message includes historical IMP session (chat) information held by the source device. Historical IMP session information may include: log/history information, presence status information, and addressing information regarding the current IMP session. Once the NOTIFY message is sent, it receives an acknowledgement OK message from the target device via the IMP server in step 465.

If step 470 determines that a SUBSCRIBE message with a passive grab indicator was received in step 420, the source device continues its participation in the chat in step 410. If however, a SUBSCRIBE message with an aggressive grab indicator was received as determined in step 470, the source device sends a REGISTER request to the IMP server to de-register from the IMP server. Note that according to SIP, the REGISTER request sent in step 480 will have an expiration parameter sent to 0 to actually indicate a request to de-register. In step 485, the source device receives an acknowledgement OK message from the IMP server. At this point, the source device has transferred its historical chat information to the target device, de-registered from the IMP server, and the flow chart ends in step 499.

Note that a single device may implement both the flow chart 300 shown in FIG. 3 and the flow chart 400 shown in FIG. 4. In fact, it is preferable to implement both flow charts in a single IMP software application. Thus, depending on the situation, an electronic device implementing a method for grab transferring an IMP session can be either the source device or the target device. Additionally, any number of on-going IMP sessions (and related historical chat information) may be transferred from a source device to a target device.

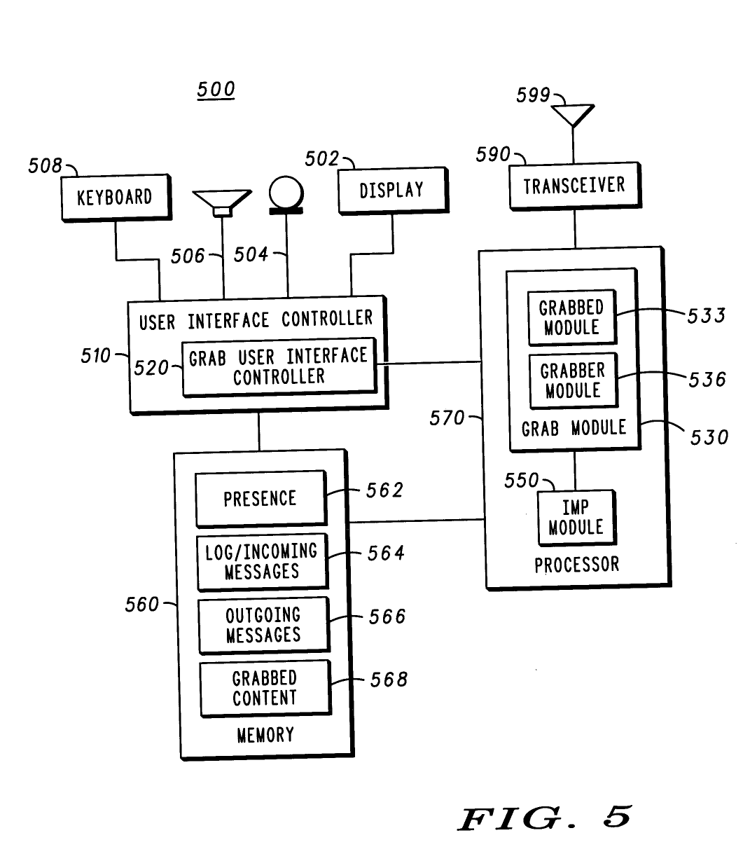

FIG. 5 shows an exemplary electronic device 500 configured for grab transferring an IMP session in accordance with the preferred embodiment. The electronic device 500 is configured to operate as both a source device and a target device, depending on the situation. The electronic device 500 is a wireless communication device such as a cellular telephone, pager, laptop computer with wireless connection, or personal digital assistance with cellular connection. The electronic device 500 could also be a wired electronic device such as a desktop computer.

The electronic device 500 has an antenna 599 and transceiver 590 for wireless communications. (In wired communications, the antenna would be replaced by a cable and the transceiver would be replaced by a modem or the like.) A processor 570 is coupled to the transceiver 590 for processing incoming and outgoing signals. Within the processor 570 is a grab module 530 that provides instructions and formulates messages for an IMP software application that enables grab transfer. The grab module 530 includes grabbed module 533 that provides instructions and formulates messages when the electronic device 500 is acting as a source device (such as the source device 101 shown in FIG. 1 and FIG. 2). Grabber module 536 provides instructions and formulates message when the electronic device 500 is acting as a target device (such as the target device 103 shown in FIG. 1 and FIG. 2).

An IMP module 550, operational to provide standard IMP functions, is coupled to the grab module 530 within the processor 570 and is also coupled to a memory 560 of the electronic device 500. The memory 560 includes a presence portion 562, a log/incoming messages portion 564, an outgoing messages portion 566, and a grabbed content portion 568. The presence portion 562 stores presence statuses for users on a “buddy list,” the log/incoming messages portion 564 stores incoming chat information, and the outgoing messages portion 566 buffers messages that are to be sent. The grabbed content portion 568 buffers historical IMP session information to compare with the contents of the log/incoming messages portion 564 during a grab transfer, as discussed previously with reference to FIG. 1 and FIG. 2. When the electronic device 500 acts as a source device, contents of memory portions 562, 564, and 566 are transferred to the grab module 530 to be formatted and sent to the transceiver 590 for receipt by the target device.

The contents of the memory portions 562, 564, and 566 contain historical IMP session information that is transferred from a source device to a target device. Conversely, historical chat information received from a source device is received through the antenna 599 and transceiver 590, analyzed by the processor 570, and buffered in grabbed content section 568 before being compared and stored in the appropriate memory portions 562, 564, and 566 of the target device.

A user interface controller 510 is coupled to the processor 570 and various user interface elements such as a keyboard 508, speaker 506, microphone 504, and display 502. Within the user interface controller 510 is a grab user interface controller 520, which provides linkages between the user interface controller 510 and the grab module 530 inside the processor 570. The grab user interface controller 520 controls the display and other user interface elements during execution of the flow charts shown in FIG. 3 and FIG. 4 and also the ancillary steps of requesting a mode selection and providing grab transfer status information to the user if desired.

Thus, the method and device for grab transferring an IMP session allows a target device to initiate a transfer of an IMP session from a source device, allows a target device to obtain historical IMP session information of an active IMP session from a source device, and allows a target device to direct a source device to de-register from an IMP server. This method requires few additions to existing IMP client applications, which can be implemented readily in software. This method does not require any changes to existing IMP servers. This method also will not disrupt operation of electronic devices that can hold IMP sessions but that are not configured to obtain historical IMP session information. For example, a source device that is not equipped to implement the flow chart 400 shown in FIG. 4 would simply disregard any SUBSCRIBE request from a target device.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

1. A method for transferring an instant messaging and presence (IMP) session from a source device to a target device comprising the steps of:
registering the target device with an IMP server;
sending historical IMP session information from the source device to the target device; and
subscribing the target device to the IMP server.

2. A method according to claim 1 wherein the step of sending comprises the steps of:
sending a grab request from the target device to the source device via the IMP server; and
sending historical IMP session information from the source device to the target device via the IMP server.

3. A method according to claim 2 wherein the step of sending a grab request comprises the steps of:
indicating a maximum amount of historical IMP session information requested by the target device.

4. A method according to claim 2 wherein the grab request directs the source device to de-register from the IMP server.

5. A method according to claim 1 further comprising the step of:
continuing the IMP session using the target device.

6. A method according to claim 5 further comprising the step of:
continuing the IMP session using the source device.

7. A method in a target device to grab transfer an instant messaging and presence (IMP) session from a source device comprising the steps of:
obtaining a selected mode for transfer of an IMP session;
sending a registration request to an IMP server;
sending a grab subscribe request to the source device;
receiving IMP session information from the source device; and
subscribing to the IMP server.

8. A method according to claim 7 wherein the step of sending a grab subscribe request to the source device comprises:
sending the grab subscribe request to the IMP server.

9. A method according to claim 7 wherein the step of receiving IMP session information from the source device comprises:
receiving IMP session information from the IMP server.

10. A method according to claim 7 wherein the step of sending a grab subscribe request to the source device comprises:
sending an aggressive grab subscribe request.

11. A method according to claim 7 wherein the step of sending a grab subscribe request to the source device comprises:
sending a passive grab subscribe request.

12. A method in a source device to transfer an instant messaging and presence (IMP) session to a target device comprising the steps of:
participating in an IMP session;
receiving a subscribe request from a target device; and
sending IMP session information to the target device.

13. A method according to claim 12 wherein the subscribe request is a passive subscribe request.

14. A method according to claim 13 further comprising the step of:
continuing the IMP session.

15. A method according to claim 12 wherein the subscribe request is an aggressive subscribe request.

16. A method according to claim 15 further comprising the step of:
de-registering from the IMP session.

17. An electronic device comprising:
a user interface controller operable to control user interface elements;
a grab user interface controller operable to obtain grab mode information from a user;
a processor, coupled to the user interface controller, having:
a grab module operable to provide instructions to enable a grab transfer of an instant messaging and presence (IMP) session from a source device;
a memory having:
a presence portion, for storing presence information;
a log/incoming messages portion, for storing incoming chat information; and
an outgoing messages portion, for storing messages to be sent.

18. An electronic device according to claim 17 wherein the grab module further comprises:
a grabbed module operable to provide instructions to enable a grab transfer of an IMP session from the electronic device to a target device.

19. An electronic device according to claim 17 wherein the grab module further comprises:
a grabber module operable to provide instructions to enable a grab transfer of an IMP session from a source device to the electronic device.

20. An electronic device according to claim 17 wherein the memory further comprises:
a grabbed content portion, for buffering historical IMP session information.

21. An electronic device according to claim 17 further comprising:
a display, coupled to the user interface controller; and
a keyboard, coupled to the user interface controller.
